(19) United States
(12) Patent Application Publication
(10) Pub. No.: US 2007/0085337 A1
(43) Pub. Date: Apr. 19, 2007

(54) Data carrier and method for manufacturing the same

(76) Inventors: Gunter Endres, Munich (DE); Georg Kruse, Aschheim (DE)

Correspondence Address: K David Crockett;Crockett & Crockett, Suite 400, 24012 Calle de la Plata, Laguna Hills, CA, 92653, US

(21) Appl. No.: 10/581,655

(22) PCT Filed: Nov. 16, 2004
(86) PCT No.: PCT/EP04/12968

§ 371 Date: May 31, 2006

(30) Foreign Application Priority Data
Dec. 2, 2003 (DE) 103 56 146.3

(51) Int. Cl. B42D 15/00

(52) U.S. Cl. 283/81

(57) ABSTRACT

The invention relates to a multilayer security element having a metal layer (20) into which are introduced, by a laser beam, identifiers (16) in the form of patterns, letters, numbers and/or images, the metal layer (20) being disposed between two translucent coating layers (26, 28). The identifiers (16) in the metal layer (20) display a watermark effect in which they appear, when viewed in transmitted light, as a positive image, and when viewed in reflected light, as a negative image.

The present invention relates to a multilayer security element having a metal layer into which are introduced, by a laser beam, identifiers in the form of patterns, letters, numbers and/or images. The present invention further relates to a method for manufacturing such a security element, as well as a data carrier that is furnished with such a security element.

It is known to personalize identification cards, such as credit cards, bank cards or identity cards, by means of laser engraving. In personalization by laser engraving, the optical properties of the card material are irreversibly changed, in the form of a desired identifier, through suitable guidance of a laser beam. To impede the reproduction of such identification cards with modern copiers, the personalization data are often introduced into metallic layers in front of a dark background. Since the metallic substrate causes a directed reflection of the incident light beams, and the detector in copiers is usually disposed such that it can pick up only the diffusely scattered light from the original, the metallic surfaces and the introduced identifiers appear all black in the copy.

From German patent specification DE 31 51 407 C1 is known a multilayer identification card that is furnished with a plastic foil as a recording medium. The plastic foil appears completely transparent in the visible wavelength range, but absorbs so strongly at the wavelength of an infrared laser used for inscribing information that a local blackening of the foil results from the effect of the laser beam. In this way, images and/or data can be inscribed in the plastic foil with good resolution.

Based on that, the object of the present invention is to specify a security element for data carriers, especially for value documents, such as an identification card, a banknote or the like, that is provided with identifiers in the form of patterns, letters, numbers and/or images, and that simultaneously offers high-grade protection against photographic or xerographic reproduction.

This object is solved by the security element having the features of the main claim. A method for manufacturing such a security element and a data carrier furnished with such a security element are specified in the coordinated claims. Developments of the present invention are the subject of the dependent claims.

The security element according to the present invention builds on the background art in that the metal layer is disposed between two translucent coating layers, causing the identifiers in the metal layer to display a watermark effect in which they appear, when viewed in transmitted light, as a positive image, and when viewed in reflected light, as a negative image.

In the context of the present description, “transparency” refers to the complete transparency of a material, “translucent” means sheer in the sense of a certain transmittance, but unlike with transparent materials, objects located behind translucent materials are perceptible only diffusely or not at all, and “opaque” refers to a material impervious to light.

Due to the translucency of the coating layers, the introduced gaps in the metal layer appear bright in transmitted light, while the remaining metal layer areas appear dark. This appearance is referred to as the positive image of the identifiers. In reflected light, on the other hand, the gaps in the metal layer appear darker than the metal layer areas, such that the image impression reverses to a negative image. This reversal corresponds to the traditional watermark effect in paper and is thus likewise referred to as a watermark effect, even though the manufacture occurs fundamentally differently compared with the watermark in paper.

The transmittance of the coating layers is preferably to be optimized such that a good contrast of the areas altered by means of laser radiation relative to the unirradiated areas is achieved. In a particularly advantageous embodiment of the present invention, in the visible spectral range, the transmittance of the translucent coating layers is less than 10%, preferably less than 5%.

The translucent coating layers can be colored and especially appear white or pastel-colored in reflected light.

Advantageously, the introduction of the identifiers into the metal layer can occur, for example, through local material ablation in the metal layer or through a local transformation of the metal into a transparent or translucent modification.

The metal layer is preferably an aluminum, copper or gold layer. Preferably, the metal layer exhibits a thickness of about 5 to 10 μm. The coating layers are preferably layers made of paper, PVC, polyester, PC or compounds thereof. The layer thickness of the coating layer varies preferably between about 100 and 250 μm.

The translucent coating layers are preferably selected such that they exhibit no appreciable absorption at the wavelength of the laser radiation used for labeling. For this, the laser wavelength is expediently selected to be in the infrared spectral range, for example at about 1.06 μm (Nd:YAG laser or Nd:glass laser) or at about 10.6 μm (CO₂ laser). For these wavelengths, there are available to those of ordinary skill in the art a number of materials that, on the one hand, are suitable for data carriers, such as identification cards, and on the other hand, combine the required translucency in the visible spectral range with low absorption at the laser wavelength.

However, it is also conceivable that at least one of the coating layers absorbs laser light and thus, viewed specifically from the side having the absorbing cover layer, a traditional image produced through blackening is present, and viewed from the other side, a transmitted light effect is visible.

The identifiers can comprise personal data, such as a signature, a birth date, a portrait or the like, and/or data relating to the data carrier, such as a serial number, a validity period, information about the issuing authority or institute or the like. Screened identifiers are particularly suited for the laser inscription, the screen dots being able to be easily produced by pulsed laser irradiation.

In a preferred embodiment, the metal layer is vapor deposited or imprinted on one of the translucent coating layers. Alternatively, the metal layer can be vapor deposited or imprinted on a transparent intermediate layer disposed between the translucent coating layers.

Expediently, one or preferably both of the translucent coating layers is provided with a protective layer that is transparent at least in the area of the identifiers.

The present invention also includes a data carrier, especially a value document, such as a banknote, an identification card or the like, that is furnished with a security element of the kind described above. Said security element can be embedded in the interior of the data carrier and thus be a part of the data carrier itself, or it can be subsequently applied to the surface of the data carrier, for example affixed. In the latter case, it is expedient for the data carrier to be formed to be transparent or translucent in the area of the identifiers of the security element. The security element can also be disposed over an opening of the data carrier, for example, a punched hole of a banknote. It is also conceivable that the data carrier itself consists of two paper layers having a metal layer lying therebetween.

In addition to the security element described, the data carrier can be provided with one or more further security features, especially with luminescent, magnetic or electrical substances, or with optically variable structures, such as holographic structures.

In a method for manufacturing a security element of the kind described above, according to the present invention, a metal layer is combined with two translucent coating layers, such that it lies between the two coating layers, and subsequently, the series of layers is impinged on with a laser beam to introduce into the metal layer identifiers in the form of patterns, letters, numbers and/or images. The identifiers are preferably introduced with pulsed laser radiation, especially in the infrared spectral range. Here, the wavelength of the laser radiation and the material of the translucent coating layers are expediently coordinated with each other in such a way that the laser radiation is strongly absorbed by the metal layer and substantially not absorbed by the translucent coating layers.

Further exemplary embodiments and advantages of the present invention are explained below by reference to the drawings, in which a depiction to scale and proportion was omitted in order to improve their clarity.

Shown are:

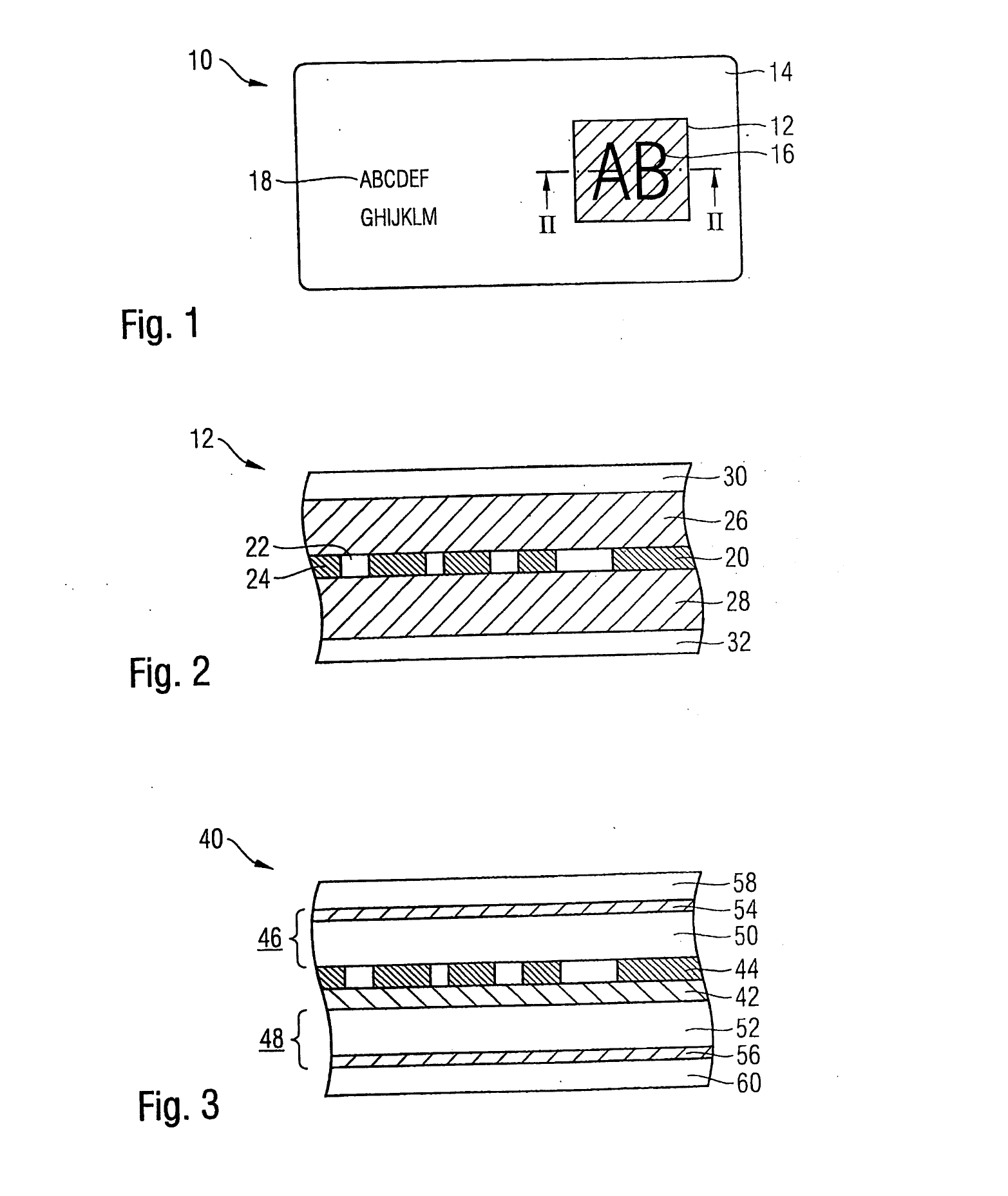

FIG. 1 a top view of an identification card having a security element according to the present invention, diagrammed schematically,

FIG. 2 a sectional view of the identification card in FIG. 1 along the line II-II, and

FIG. 3 a sectional view of a security element according to another exemplary embodiment of the present invention.

FIG. 1 shows a top view of an identification card 10 that includes a security element 12 according to the present invention, diagrammed schematically. In the exemplary embodiment, the security element 12 is part of the card body 14 of the identification card 10.

FIG. 2 shows a cross section through the identification card 10 in the area of the security element 12 along the line II-II of FIG. 1. In other embodiments, the security element can also be a separately manufactured element that is applied, for example affixed, to a data carrier, such as the card body 14.

The security element 12 includes a metal layer 20 into which identifiers 16 are introduced with a laser beam, in the present case in the form of the letter sequence “AB”. In addition, the identification card 10 includes further personal or non-personal data 18 that can be applied to the card in any suitable methods. Depending on the application of the identification card 10, the data 16 and 18 comprise, for example, the name, the birth date, the nationality or a portrait of the holder, the issuing authority or the issuing institute, the issue date and the like.

As is best discernible in the sectional view in FIG. 2, the security element 12 includes, in addition to the metal layer 20, an upper and a lower translucent coating layer 26 and 28, each of which is covered and protected by a transparent plastic foil 30 and 32. In the exemplary embodiment, the translucent coating layers 26 and 28 consist of white-colored polycarbonate foils of a thickness of about 150 μm. While such foils are often referred to as opaque in other contexts, the present invention depends precisely on the fact that the foils are not completely nontransparent, but rather admit a certain, if small, portion of the light when illuminated from the back of the card. Accordingly, they are referred to in this description as translucent, in other words light-transmitting.

To introduce the identifiers 16 into the identification card 10, the card is impinged on with laser pulses from an infrared laser, for example a Nd:YAG laser having a wavelength of 1.064 μm. For the infrared radiation, the plastic foils 30 and 32 and the white polycarbonate foils 26 and 28 exhibit a negligible absorption and are not changed by the laser radiation. The metal layer 20, in contrast, absorbs the laser radiation so strongly that the energy deposited generates a local change of state in the metal layer. This change of state in the metal layer 20 can, for example, consist in partial or complete local ablation of the metal layer or in a local transformation of the metal layer into a transparent or translucent modification.

In this way, through a suitable selection of beam diameter and pulse energy, identifiers can be introduced into the metal layer 20 in the form of patterns, letters, numbers or images that consist of areas 22 in which the metal layer was altered, and areas 24 in which the metal layer remains unaltered.

When the identification card 10 is viewed in transmitted light, a positive image of the identifiers is then perceptible in which light can reach the viewer's eye through the areas 22, which thus appear light, while the remaining metal layer in the areas 24 completely blocks the light impinging from the back of the card, such that these areas appear dark.

The image impression of the identifiers reverses in reflected light. When viewed in reflected light, the impinging light is reflected more strongly in the metal layer areas 24 than in the sheer areas 22, such that the metal layer areas 24 appear light and the metal-free areas 22 comparatively dark. This change effect is analogous to the effects that occur with traditional watermarks, and is thus likewise referred to in the present description as a watermark effect.

A further exemplary embodiment of a security element 40 according to the present invention is depicted in FIG. 3. The security element 40 exhibits a transparent polycarbonate foil 42 of a thickness of about 100 μm, on which a thin metal layer 44, for example an aluminum, copper or gold layer, is vapor deposited. The coated polycarbonate foil 42 is embedded between two translucent cover foils 46 and 48, each of which consists of a transparent polyester foil 50 or 52 and printing layers 54 and 56 applied thereto. For protection, further transparent polyester foils 58 and 60 are disposed over the cover foils 46 and 48.

In this exemplary embodiment, the translucency of the cover foils 46 and 48 is achieved through the printing layers 54 and 56 and can be adjusted within a broad range as needed through the printing ink's degree of coverage and the thickness of the printing layer.

Furthermore, the printing inks are selected such that the printing layers are substantially transparent to the laser radiation used for labeling. For personalization, the metal layer 44 of the security element 40 is provided with identifiers as described above, and a watermark effect is thus produced in the. data carrier furnished with the security element.

1. A multilayer security element having a metal layer into which are introduced, by a laser beam, identifiers in the form of patterns, letters, numbers and/or images, characterized in that the metal layer is disposed between two translucent coating layers, whose transmittance in the visible spectral range is less than 10%, causing the identifiers in the metal layer to display a watermark effect in which they appear, when viewed in transmitted light, as a positive image, and when viewed in reflected light, as a negative image.

2. The security element according to claim 1, characterized in that the transmittance of the translucent coating layers in the visible spectral range is less than 5%.

3. The security element according to claim 1, characterized in that the translucent coating layers are colored, and appear white or pastel-colored in reflected light.

4. The security element according to claim 1, characterized in that the introduction of the identifiers occurs through material ablation in the metal layer.

5. The security element according to claim 1, characterized in that the introduction of the identifiers occurs through a local transformation of the metal into a transparent or translucent modification.

6. The security element according to claim 1, characterized in that the translucent coating layers exhibit no appreciable absorption at the wavelength of the laser radiation used for labeling.

7. The security element according to claim 1, characterized in that the identifiers comprise personal data, such as a signature, a birth date, a portrait or the like.

8. The security element according to claim 1, characterized in that the identifiers comprise data relating to the data carrier, such as a serial number, a validity period or the like.

9. The security element according to claim 1, characterized in that the identifiers are present in screened form.

10. The security element according to claim 1, characterized in that the metal layer is vapor deposited or imprinted on one of the translucent coating layers.

11. The security element according to claim 1, characterized in that the metal layer is vapor deposited or imprinted on a transparent intermediate layer disposed between the translucent coating layers.

12. The security element according to claim 1, characterized in that one or both of the translucent coating layers is provided with a protective layer that is transparent at least in the area of the identifiers.

13. A data carrier comprising a value document, such as a banknote, identification card or the like, having a security element according to claim 1.

14. The data carrier according to claim 13, characterized in that the security element is embedded in the interior of the data carrier or applied to the surface of the data carrier.

15. The data carrier according to claim 13, characterized in that the data carrier is provided with one or more further security features.

16. A method for manufacturing a security element according to claim 1, in which
a metal layer is combined with two translucent coating layers, whose transmittance in the visible spectral range is less than 10%, such that it lies between the two coating layers, and
subsequently, the series of layers is impinged on with a laser beam to introduce into the metal layer identifiers in the form of patterns, letters, numbers and/or images.

17. The method according to claim 16, characterized in that the identifiers are introduced with pulsed laser radiation, especially in the infrared spectral range.

18. The method according to claim 16, characterized in that the wavelength of the laser radiation and the material of the translucent coating layers are coordinated with each other in such a way that the laser radiation is strongly absorbed by the metal layer and substantially not absorbed by the translucent coating layers.

19. The data carrier according to claim 15, characterized in that the further security features comprise luminescent, magnetic or electrical substances, or optically variable structures, such as holographic structures.
